(19) United States
(12) Patent Application Publication
(10) Pub. No.: US 2017/0046762 A1
(43) Pub. Date: Feb. 16, 2017

(54) INFORMATION PROVIDING SYSTEM, DISPLAY CONTROL DEVICE, INFORMATION EQUIPMENT, AND INFORMATION PROVIDING METHOD

(71) Applicant: MITSUBISHI ELECTRIC CORPORATION, Tokyo (JP)

(72) Inventors: Hidekazu ARITA, Tokyo (JP); Mitsuo SHIMOTANI, Tokyo (JP)

(73) Assignee: MITSUBISHI ELECTRIC CORPORATION, Tokyo (JP)

(21) Appl. No.: 15/307,337

(22) PCT Filed: Aug. 6, 2014
(86) PCT No.: PCT/JP2014/070696

§ 371 Date: Oct. 27, 2016

(51) Int. Cl. G06Q 30/06; G01C 21/32; G06N 5/04

(52) U.S. Cl. CPC G06Q 30/0623; G06N 5/048; G01C 21/32; G06Q 30/0639

(57) ABSTRACT

It is an object of the present invention to provide an information providing system and an information providing method capable of providing information with high reliability, and provide an information equipment capable of transmitting information which contributes to the information to be provided by the information providing system, to the information providing system. The information providing system of the present invention includes a processor to execute a program and a memory to store the program. The program, when executed by the processor, performs processes of acquiring facility use information and service providing information, checking the facility use information with the service providing information, and updating availability information indicating an availability state of the facility on the basis of a check result obtained in the checking. The checking includes checking the facility use information with the service providing information on a one-to-one basis.

### TECHNICAL FIELD

The present invention relates to an information providing system and an information providing method for providing information on whether a facility is available or not to a vehicle which uses the facility, and an information equipment for notifying the information providing system that the facility was used.

### BACKGROUND ART

In recent years, electric vehicles (EVs) have become widespread in the context of rising problems such as global warming and air pollution, and the like. Further, as the electric vehicles have become widespread, charging facilities for charging the electric vehicles have rapidly increased.

Since it takes a longer time to refuel (charge) the electric vehicle than to refuel a gasoline-powered vehicle (a car which runs with gasoline as fuel), when the fuel of the electric vehicle runs short and the electric vehicle cannot self-run, it takes a long time until the electric vehicle is charged and becomes able to self-run. Therefore, it is important for the electric vehicles to be surely charged by a charging facility when charging is needed (before the electric vehicle becomes not able to self-run).

As to an electric vehicle capable of displaying a map, it is possible to select a desired one out of charging facilities displayed on the map and go to the selected charging facility to charge the electric vehicle. In a case where a charging facility is newly established, the newly-established charging facility is registered at the timing of updating map data in most cases. On the other hand, in a case where a charging facility gets out of business, it is sometimes delayed to reflect the out-of-business of the charging facility on the map data (register the out-of-business of the charging facility at the timing of updating the map data).

In the above case, for example, when an electric vehicle having a little amount of remaining power travels in a region where there are a few charging facilities, if a charging facility at which the electric vehicle calls by to be charged got out of business, there is a higher probability that the electric vehicle cannot be charged and should become not able to self-run. Not only in the case where the charging facility has got out of business, but also in a case where the charging facility is closed or out of business hours, the same applies. Further, there may be a possible case where a user actively selects a preferable charging facility, such as a charging facility with lower electricity rate required for charging, another charging facility that allows the user to perform a quick charge, or the like. Also in such a case, when the selected charging facility is out of business, closed, or out of business hours, there arises a problem that charging cannot be performed. Thus, it is desirable that information on whether the charging facility is available or not should be newest.

Conventionally, disclosed is a technique that an information center (charging facility information collection center) acquires information on a charging facility from a moving body (vehicle), updates information on the charging facility on the basis of the acquired information, and provides the moving body with the information on whether the charging facility is available or not (for example, Patent Documents 1 and 2).

### PRIOR-ART DOCUMENTS

### Patent Documents

[Patent Document 1] Japanese Patent Application Laid-Open No. 2013-148412

[Patent Document 2] Japanese Patent Application Laid-Open No. 2013-253891

### SUMMARY OF INVENTION

### Problems to be Solved by the Invention

In Patent Documents 1 and 2, the information on the charging facility is updated on the basis of the information acquired only from the moving body (vehicle). If a vehicle with malevolence, however, sends false information to the center, for example, the center updates the information on the charging facility on the basis of the false information, and this causes a problem of reducing the reliability of the updated information.

Further, even when the information on the charging facility is updated on the basis of the information acquired only from the charging facility, for example, if the charging facility sends false information to the center, the center updates the information on the charging facility on the basis of the false information, and this causes the problem of reducing the reliability of the updated information.

The present invention is intended to solve the above problems, and it is an object of the present invention to provide an information providing system and an information providing method capable of providing information with high reliability, and provide an information equipment capable of transmitting information which contributes to the information to be provided by the information providing system, to the information providing system.

### Means for Solving the Problems

In order to solve the above-described problems, the present invention is intended for an information providing system. According to the present invention, the information providing system includes an information acquiring unit for acquiring facility use information indicating that a vehicle has used a facility and service providing information indicating that the facility has provided the vehicle with a service; an information check unit for checking the facility use information with the service providing information, both of which are acquired by the information acquiring unit; and a controller for updating availability information indicating an availability state of the facility on the basis of a check result obtained by the information check unit.

The present invention is also intended for an information equipment. According to the present invention, the information equipment includes a transmitting unit for transmitting facility use information indicating that an own-vehicle has used a facility, to the outside; and a transmission/reception unit communicably connected to the facility, being capable of receiving service providing information indicating that the facility has provided the own-vehicle with a service or of transmitting the facility use information to the facility.

The present invention is still also intended for an information providing method. According to the present invention, the information providing method includes the steps of acquiring facility use information indicating that a vehicle has used a facility and service providing information indicating that the facility has provided the vehicle with a service; making a check of the facility use information with the service providing information, both of which are acquired; and updating availability information indicating an availability state of the facility on the basis of a result of the check.

### Effects of the Invention

According to the present invention, since the information providing system includes the information acquiring unit for acquiring facility use information indicating that a vehicle has used a facility and service providing information indicating that the facility has provided the vehicle with a service, the information check unit for checking the facility use information with the service providing information, both of which are acquired by the information acquiring unit, and the controller for updating availability information indicating an availability state of the facility on the basis of a check result obtained by the information check unit, it is possible to provide information with high reliability.

Further, since the information equipment includes a transmitting unit for transmitting facility use information indicating that an own-vehicle has used a facility, to the outside, and a transmission/reception unit communicably connected to the facility, being capable of receiving service providing information indicating that the facility has provided the own-vehicle with a service or of transmitting the facility use information to the facility, it is possible to transmit information which contributes to the information to be provided by the information providing system, to the information providing system.

Furthermore, since the information providing method includes the steps of acquiring facility use information indicating that a vehicle has used a facility and service providing information indicating that the facility has provided the vehicle with a service, making a check of the facility use information with the service providing information, both of which are acquired, and updating availability information indicating an availability state of the facility on the basis of a result of the check, it is possible to provide information with high reliability.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing an exemplary constitution of an information providing apparatus in accordance with a first preferred embodiment of the present invention;

FIG. 2 is a block diagram showing another exemplary constitution of the information providing apparatus in accordance with the first preferred embodiment of the present invention;

FIGS. 3 and 4 are flowcharts each showing an exemplary operation of the information providing apparatus in accordance with the first preferred embodiment of the present invention;

FIG. 5 is a block diagram showing an exemplary constitution of a charging facility in accordance with the first preferred embodiment of the present invention;

FIG. 6 is a block diagram showing an exemplary constitution of a vehicle in accordance with the first preferred embodiment of the present invention;

FIG. 7 is a block diagram showing an exemplary constitution of an information providing apparatus in accordance with a second preferred embodiment of the present invention;

FIG. 8 is a flowchart showing an exemplary operation of the information providing apparatus in accordance with the second preferred embodiment of the present invention;

FIG. 9 is a graph for explaining an estimation of new-establishment of the charging facility in accordance with a third preferred embodiment of the present invention;

FIGS. 10 to 12 are graphs each for explaining an estimation of in-service of the charging facility in accordance with the third preferred embodiment of the present invention;

FIG. 13 is a graph for explaining an estimation of out-of-service of the charging facility in accordance with the third preferred embodiment of the present invention;

FIGS. 14 and 15 are views each for explaining an estimation of out-of-business of the charging facility in accordance with the third preferred embodiment of the present invention;

FIG. 16 is a block diagram showing an exemplary constitution of an information providing apparatus in accordance with a fourth preferred embodiment of the present invention;

FIG. 17 is a flowchart showing an exemplary operation of the information providing apparatus in accordance with the fourth preferred embodiment of the present invention;

FIG. 18 is a flowchart showing an exemplary operation of a probe car in accordance with the fourth preferred embodiment of the present invention;

FIG. 19 is a block diagram showing another exemplary constitution of the information providing apparatus in accordance with the fourth preferred embodiment of the present invention;

FIG. 20 is a block diagram showing an exemplary constitution of a display control device in accordance with a fifth preferred embodiment of the present invention;

FIGS. 21 and 22 are views each showing an exemplary display of a display device in accordance with the fifth preferred embodiment of the present invention;

FIG. 23 is a block diagram showing an exemplary constitution of an information providing system in accordance with the preferred embodiments of the present invention; and

FIG. 24 is a block diagram showing another exemplary constitution of the information providing system in accordance with the preferred embodiments of the present invention.

### DESCRIPTION OF EMBODIMENT(S)

With reference to figures, the preferred embodiments of the present invention will be discussed below.

### The First Preferred Embodiment

First, description will be made on a constitution of an information providing system in accordance with the first preferred embodiment of the present invention. Further, in the present preferred embodiment and the following preferred embodiments, described will be a case where the information providing system is implemented solely by an information providing apparatus.

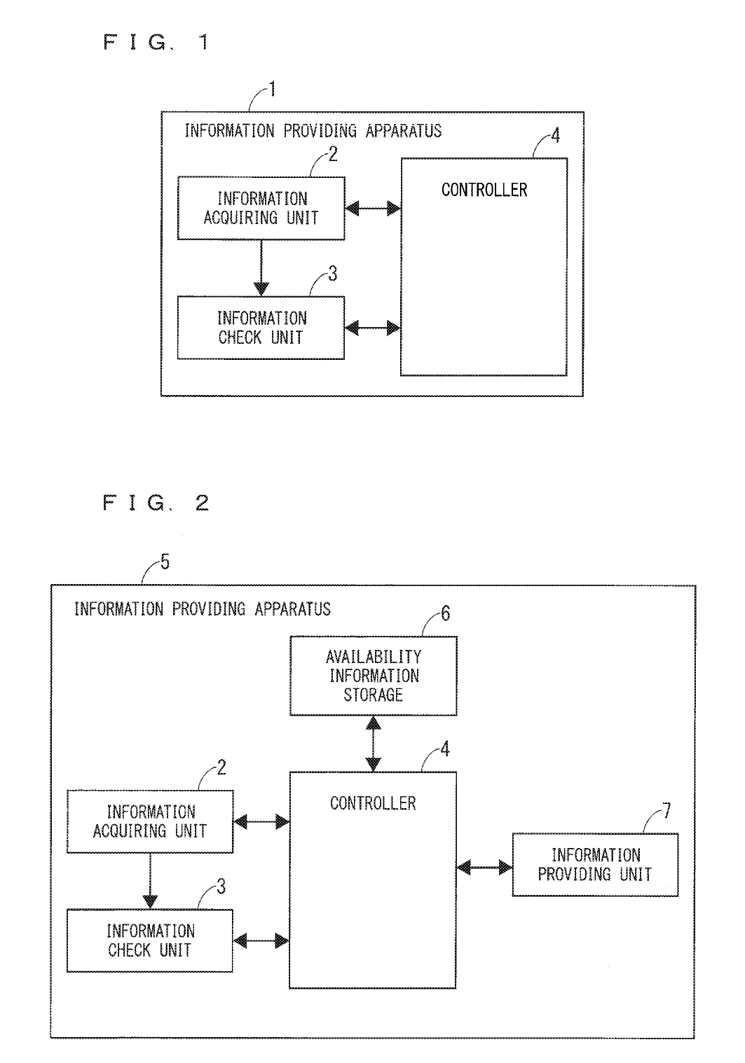

FIG. 1 is a block diagram showing an exemplary constitution of an information providing apparatus 1 in accordance with the first preferred embodiment. FIG. 1 shows minimum constituent elements constituting the information providing apparatus 1.

As shown in FIG. 1, the information providing apparatus 1 comprises at least an information acquiring unit 2, an information check unit 3, and a controller 4.

The information acquiring unit 2 acquires facility use information indicating that a vehicle has used a facility and service providing information indicating that the facility has provided the vehicle with a service. Further, the following description will be made, assuming that a vehicle is an electric vehicle (EV) (hereinafter, referred to as a vehicle) and a facility that the vehicle uses is a charging facility (hereinafter, referred to as a charging facility).

Herein, the facility use information includes an ID of a vehicle which used a charging facility, specific information of the vehicle, a use start time of the charging facility, a use end time of the charging facility, a service content provided by the charging facility, charging facility information for specifying the charging facility, and the like. Further, the specific information of the vehicle includes the type of the vehicle or the type of energy (EV, Plug-in Hybrid Vehicle (P-EV), or the like) that drives the vehicle. The charging facility information included in the facility use information includes a name of the charging facility, an ID of the charging facility, position information of the charging facility, position information of the vehicle at the time when the vehicle uses the charging facility, and the like. The service content includes a service content which the vehicle can use in the facility, such as “charge”, “quick charge”, or the like. Further, the name of the charging facility, the ID of the charging facility, and the position information of the charging facility may be acquired in advance from the charging facility, or when these information are included in map information, these information may be acquired from the map information.

Furthermore, the service providing information includes a service providing start time, a service providing end time, a provided service content provided to the vehicle, charging facility information for specifying the charging facility, and the like. The charging facility information included in the service providing information includes the name of the charging facility, the ID of the charging facility, the position information of the charging facility, and the like. The provided service content includes a service content with which the facility provides the vehicle, such as “charge”, “quick charge”, or the like.

The information check unit 3 checks the facility use information with the service providing information, both of which are acquired by the information acquiring unit 2.

The controller 4 updates availability information indicating an availability state of the facility on the basis of a check result obtained by the information check unit 3. Herein, the availability information includes the ID of the charging facility, the position information of the charging facility, new-establishment of the charging facility, in-service of the charging facility, out-of-service of the charging facility, out-of-business of the charging facility, days of week and a time on/at which the service is provided, the provided service content, and the like. Further, the new-establishment of the charging facility refers to that the charging facility has been newly established. The out-of-business of the charging facility refers to that the charging facility went out of business. The in-service of the charging facility refers to that the charging facility is open and in service. The out-of-service of the charging facility refers to that the charging facility is out of business hours.

Next, described will be another constitution of the information providing apparatus 1 including the information acquiring unit 2, the information check unit 3, and the controller 4 which are described above.

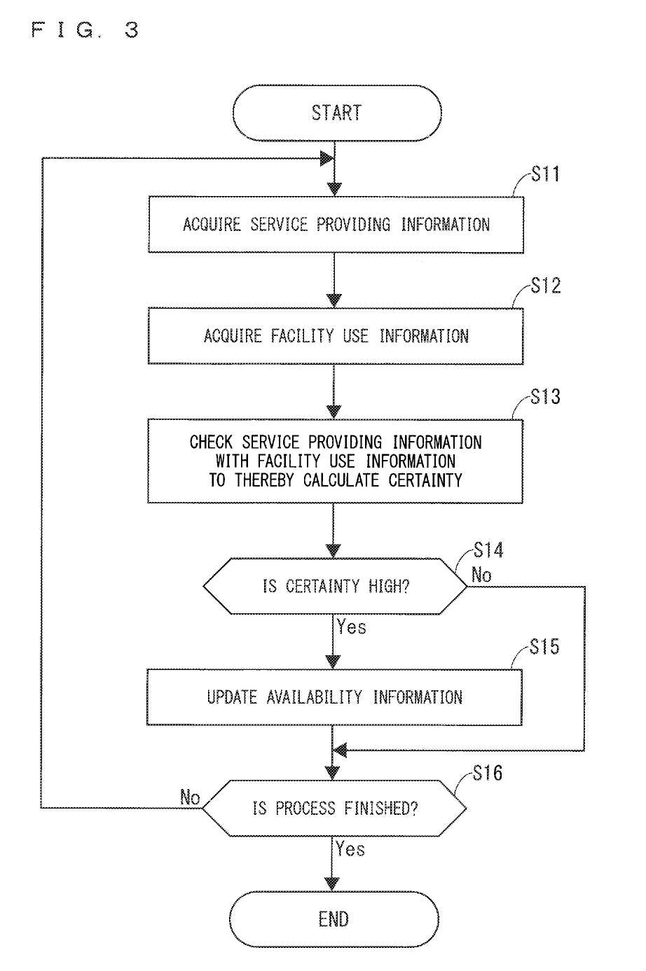

FIG. 2 is a block diagram showing an exemplary constitution of an information providing apparatus 5.

As shown in FIG. 2, the information providing apparatus 5 comprises the information acquiring unit 2, the information check unit 3, the controller 4, an availability information storage 6, and an information providing unit 7.

The information acquiring unit 2 acquires the facility use information and the service providing information. Specifically, the information acquiring unit 2 acquires the facility use information from a vehicle or a communication terminal (first communication terminal) communicable with the vehicle, and acquires the service providing information from a charging facility or a communication terminal (second communication terminal) communicable with the charging facility.

Further, the information acquiring unit 2 may acquire the facility use information and the service providing information by any one of various methods, not limited to the above method. For example, the information acquiring unit 2 may acquire the facility use information and the service providing information from the vehicle or the communication terminal communicable with the vehicle. In this case, the vehicle needs to acquire the service providing information from the charging facility in advance.

Furthermore, the information acquiring unit 2 may acquire the facility use information and the service providing information from the charging facility or the communication terminal communicable with the charging facility. In this case, the charging facility needs to acquire the facility use information from the vehicle in advance.

Moreover, the information acquiring unit 2 may acquire the facility use information and the service providing information from a communication terminal communicable with the vehicle and the charging facility.

The information check unit 3 checks the facility use information with the service providing information, both of which are acquired by the information acquiring unit 2, and calculates a certainty of the facility use information and the service providing information. Specifically, the information check unit 3 calculates the certainty of the facility use information and the service providing information on the basis of a degree of coincidence of the facility use information and the service providing information. Herein, the certainty refers to a certainty of the information (facility use information and service providing information) on each charging action.

For example, the certainty is determined by combination of the following (1) and (2), and when the certainty is larger than a predetermined threshold value Pth, the certainty is determined to be high.

(1) A rate at which corresponding pieces of information of the facility use information and the service providing information coincide with each other within a predetermined acceptable range.

(2) A value obtained by calculation with weighting for each type of information in (1) described above.

The determination in (1) described above is made as follows.

Specifically, when it is assumed that parameters of the service providing information are {a1, a2, . . . , aN} and those of the facility use information are {b1, b2, . . . , bN}, the certainty P=Σf(an, bn)/N, where n=1 to N.

f(an,bn)=1 when |an−bn|≦ABth(n)

f(an,bn)=0 when |an−bn|>ABth(n)

ABth(n) is an acceptable error range of the information an and bn. For example, 20 m in the case of the position information, 10 minutes in the case of time information, the number of characters in the case of characters, or the like may be used.

Herein, when ABth(n)=0, this means the strictest degree of coincidence, and when both the information completely coincide with each other, these information are determined to be coincident with each other.

As the determination of the certainty, when P≧Pth, for example, the certainty of the information is determined to be high. In a system where the certainty is determined to be high when all the information coincide, Pth=1, or in another system where an error is acceptable in some degree, Pth is a value smaller than 1.

The determination in (2) described above is made by calculation with the weighting for each information n set as “cn”.

For example, the weighting for the position information is set high in a system where priority is given to the position information, and the weighting for the time information is set high in another system where priority is given to the time information.

P=Σcn·f(a,bn)/NT

f(an, bn) is not limited to the value of 0 or 1 but may be a value in the range from 0 to 1 due to an error. Further, the above calculation equations are only examples and the determination is not limited to any one of the above calculation equations.

Specifically, the information check unit 3 checks the position information of the vehicle included in the facility use information with the position information of the charging facility included in the service providing information, and when both the position information are within a predetermined acceptable error (positional error) range, it is determined that these positions are coincident with each other and the certainty of the facility use information and the service providing information is high (both are reliable information). In other words, the information check unit 3 determines that the certainty is high when the two pieces of information that are checked with each other are coincident.

Besides the above case, for example, other two pieces of information, such as the use start time of the charging facility and the service providing start time, the use end time of the charging facility and the service providing end time, the service content provided by the charging facility and the provided service content which is provided to the vehicle, or the ID of the charging facility included in the facility use information and that included in the service providing information, may be checked. Further, when the times are checked, an error (error of the time) may be considered.

When both the information are not coincident as a result of the above check, the information check unit 3 determines that the certainty of at least one of the facility use information and the service providing information is low (at least one is not reliable information).

Further, when the information acquiring unit 2 acquires fee transferring information indicating that an electronic fee has been transferred between the vehicle and the charging facility, from at least one of the vehicle and the charging facility, the information check unit 3 may calculate the certainty of the facility use information and the service providing information also on the basis of the fee transferring information. For example, when the information acquiring unit 2 also acquires the fee transferring information together with the facility use information and the service providing information from the vehicle or the charging facility, the information check unit 3 determines that the certainty of the facility use information and the service providing information which are acquired with the fee transferring information is high. Further, when the vehicle pays the fee to the charging facility by a credit card, the information acquiring unit 2 acquires the facility use information and the service providing information from the vehicle or the charging facility, and the information acquiring unit 2 also acquires the fee transferring information from the management company of the credit card, the information check unit 3 may determine that the certainty of the facility use information and the service providing information is higher than that in the above case (where the information acquiring unit 2 acquires the fee transferring information from the vehicle or the charging facility).

The controller 4 updates the availability information indicating the availability state of the facility stored in the availability information storage 6 on the basis of the check result obtained by the information check unit 3. Specifically, the controller 4 updates the availability information on the basis of the certainty calculated by the information check unit 3. For example, the controller 4 updates the availability information on the basis of the facility use information and the service providing information whose certainty is determined to be high. Further, the controller 4 controls respective operations of the information acquiring unit 2, the information check unit 3, the availability information storage 6, and the information providing unit 7.

The availability information storage 6 stores therein the availability information.

The availability information storage 6 is a memory device, such as a Hard Disk Drive (HDD)), a semiconductor memory, or the like.

The information providing unit 7 provides the availability information stored in the availability information storage 6, in response to a request from the outside.

Next, described will be an operation of the information providing apparatus 5.

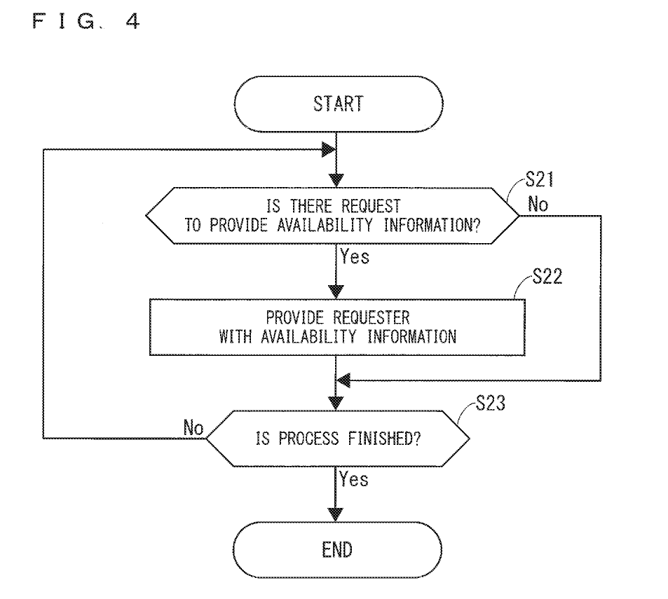

FIG. 3 is a flowchart showing an exemplary operation of the information providing apparatus 5, and shows an update process of the availability information.

In Step S11, the information acquiring unit 2 acquires the service providing information.

In Step S12, the information acquiring unit 2 acquires the facility use information.

In Step S13, the information check unit 3 checks the service providing information with the facility use information, to thereby calculate the certainty thereof.

In Step S14, the information check unit 3 determines whether the calculated certainty is high or not. When the information check unit 3 determines that the certainty is high, the process goes to Step S15. On the other hand, when the information check unit 3 does not determine that the certainty is high, the process goes to Step S16.

In Step S15, the controller 4 updates the availability information stored in the availability information storage 6 on the basis of the service providing information and the facility use information whose certainty is determined to be high by the information check unit 3.

In Step S16, the controller 4 determines whether to finish the operation. When the operation should be finished, the process is finished. On the other hand, when the operation should not be finished, the process goes to S11.

FIG. 4 is a flowchart showing an exemplary operation of the information providing apparatus 5, and shows an information providing process.

In Step S21, the controller 4 determines whether or not there is a request to provide the availability information from the outside. When there is a request, the process goes to Step S22. On the other hand, when there is no request, the process goes to Step S23.

In Step S22, the information providing unit 7 provides the availability information stored in the availability information storage 6 to the outside.

In Step S23, the controller determines whether to finish the operation. When the operation should be finished, the process is finished. On the other hand, when the operation should not be finished, the process goes to S21.

Next, respective constitutions of the charging facility and the vehicle will be described.

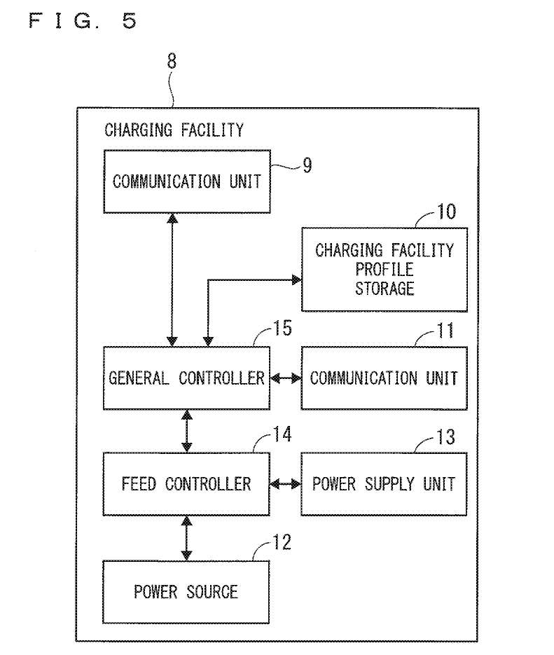

FIG. 5 is a block diagram showing an exemplary constitution of a charging facility 8.

As shown in FIG. 5, the charging facility 8 comprises a communication unit 9, a charging facility profile storage 10, a communication unit 11, a power source 12, a power supply unit 13, a feed controller 14, and a general controller 15.

The communication unit 9 performs communication with the information providing apparatus 5 via a wireless LAN or the internet. Specifically, the communication unit 9 sends the service providing information, the facility use information, or both the service providing information and the facility use information to the information providing apparatus 5. The sent information is acquired by the information acquiring unit 2 of the information providing apparatus 5.

The charging facility profile storage 10 stores therein various information on the charging facility (for example, the name of the charging facility, the ID of the charging facility, the position information of the charging facility, the provided service content, and the like). The charging facility profile storage 10 is a memory device, such as a Hard Disk Drive (HDD), a semiconductor memory, or the like.

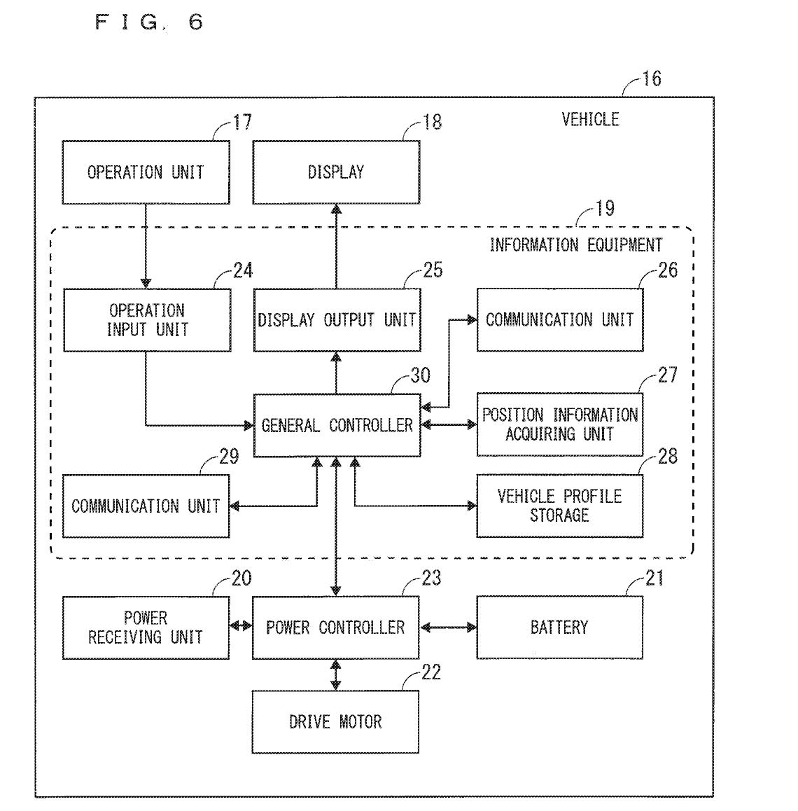

The communication unit 11 performs communication with the vehicle (a communication unit 29 shown in FIG. 6 and described later) via a wireless LAN or the like. Specifically, the communication unit 11 receives a request to supply electric power from the vehicle, sends the service providing information to the vehicle, or the like.

The power source 12 is a source of supply for receiving the electric power from an electric power infrastructure and supplying the vehicle with the electric power.

The power supply unit 13 is connected to the vehicle (a power receiving unit 20 shown in FIG. 6 and described later) with a wired or wireless connection, to supply the vehicle with the electric power.

The feed controller 14 controls the power source 12 to supply the electric power to the power supply unit 13 in accordance with an instruction of the general controller 15.

The general controller 15 controls respective operations of the communication unit 9, the charging facility profile storage 10, the communication unit 11, and the feed controller 14. Further, the general controller 15 calculates the service providing start time and the service providing end time included in the service providing information.

FIG. 6 is a block diagram showing an exemplary constitution of the vehicle 16.

As shown in FIG. 6, the vehicle 16 comprises an operation unit 17, a display 18, an information equipment 19, a power receiving unit 20, a battery 21, a drive motor 22, and a power controller 23.

The operation unit 17 receives an input operation of a user. Herein, as the operation unit 17, for example, a touch panel, a hardware key, a voice input (e.g., a microphone), or the like may be used. The display 18 displays various information such as the map information or the like. At least one of the operation unit 17 and the display 18 may be united with the information equipment 19 as one body, or may be provided separately.

The power receiving unit 20 receives the electric power from the power supply unit 13 of the charging facility 8.

The battery 21 accumulates the electric power needed to drive the drive motor 22. The drive motor 22 drives the vehicle 16.

The power controller 23 controls the power receiving unit 20, the battery 21, and the drive motor 22 in accordance with the control of a general controller 30 described later.

The information equipment 19 comprises an operation input unit 24, a display output unit 25, a communication unit 26, a position information acquiring unit 27, a vehicle profile storage 28, a communication unit 29, and a general controller 30.

The operation input unit 24 inputs information of input operation received by the operation unit 17. The display output unit 25 generates information to be displayed on the display 18, as a display signal, and outputs the generated display signal to the display 18, in accordance with an instruction of the general controller 30.

The communication unit 26 performs communication with the information providing apparatus 5 via a wireless LAN or the internet. Specifically, the communication unit 26 sends the service providing information, the facility use information, or both the service providing information and the facility use information to the information providing apparatus 5. In other words, the communication unit 26 has a function as a transmitting unit for transmitting the facility use information and the service providing information to the information providing apparatus 5. The transmitted information is acquired by the information acquiring unit 2 of the information providing apparatus 5.

The position information acquiring unit 27 acquires the current position information (current position) of the vehicle 16. Specifically, the position information acquiring unit 27 receives the position information of the vehicle 16 from, for example, a Global Positioning System (GPS) satellite. Further, the position information acquiring unit 27 may acquire the accurate current position of the vehicle 16 by correcting the position information of the vehicle 16 received from the GPS satellite on the basis of the map information, information such as vehicle speed or the like acquired via an in-vehicle LAN (both not shown), or the like.

The vehicle profile storage 28 stores therein the ID of the vehicle. The vehicle profile storage 28 is a memory device, such as a Hard Disk Drive (HDD), a semiconductor memory, or the like.

The communication unit 29 performs communication with the communication unit 11 of the charging facility 8 via a wireless LAN or the like. Specifically, the communication unit 29 sends a request to supply the electric power to the charging facility 8, sends the facility use information to the charging facility 8, or receives the service providing information from the charging facility 8. In other words, the communication unit 29 has a function as a transmission/reception unit communicably connected to the charging facility, being capable of receiving the service providing information or transmitting the facility use information to the charging facility 8.

The general controller 30 controls respective operations of the power controller 23, the operation input unit 24, the display output unit 25, the communication unit 26, the position information acquiring unit 27, the vehicle profile storage 28, and the communication unit 29. Further, the general controller 30 calculates the use start time of the charging facility and the use end time of the charging facility included in the facility use information.

Further, when a map information storage (not shown) for storing therein the map information is provided, the name of the charging facility, the ID of the charging facility, the position information of the charging facility, and the like may be included in the map information

From the above description, the charging facility 8 and the vehicle 16 are capable of sending the service providing information, the facility use information, or both the service providing information and the facility use information to the information providing apparatus 5. Further, between the charging facility 8 and the vehicle 16, various information including the facility use information and the service providing information can be transferred.

Herein, described will be respective operations of the vehicle 16 and the charging facility 8 in a case where the vehicle 16 sends the facility use information and the service providing information to the information providing apparatus 5.

First, the vehicle 16 and the charging facility 8 become a system for transferring the electric power. Specifically, the power receiving unit 20 of the vehicle 16 and the power supply unit 13 of the charging facility 8 are connected to each other directly or indirectly (not in contact therewith).

Next, communication is established between the communication unit 29 of the vehicle 16 and the communication unit 11 of the charging facility 8.

Subsequently, when the vehicle 16 sends a request for electric power supply to the charging facility 8 and the charging facility 8 receives the request for electric power supply, the electric power supply is started.

Next, when the vehicle 16 sends a notification of charge completion to the charging facility 8, the supply of electric power from the charging facility 8 is completed. At that time, the vehicle 16 stores therein the use start time and the use end time of the charging facility 8. Further, the charging facility 8 stores therein the service providing start time and the service providing end time.

Subsequently, the vehicle 16 receives the service providing information from the charging facility 8.

Next, the vehicle 16 sends the facility use information and the service providing information to the information providing apparatus 5.

Further, though the case where the vehicle 16 sends the facility use information and the service providing information to the information providing apparatus 5 has been described above, the same applies to a case where the charging facility 8 sends the facility use information and the service providing information to the information providing apparatus 5.

Furthermore, between the charging facility 8 and the vehicle 16, Power Line Communication (PLC) may be performed. In this case, the communication unit 11 is connected to the power supply unit 13 in the charging facility 8 and the communication unit 29 is connected to the power receiving unit 20 in the vehicle 16, to thereby perform the PLC.

Further, when the vehicle 16 has a function of payment by credit card (for example, the vehicle 16 is provided with a device for making a credit card payment or a device for DSRC (registered trademark) or the like), or when the vehicle 16 makes access to the management company of the credit card to make a payment, the information (fee transferring information) indicating that the payment is made by the credit card may be sent to the information providing apparatus 5. At that time, the management company of the credit card may send the fee transferring information to the information providing apparatus 5. Furthermore, the same applies to the charging facility 8.

Thus, according to the first preferred embodiment, the information providing apparatus 5 can store the availability information with high reliability and provide the availability information to the outside as necessary. Further, the charging facility 8 and the vehicle 16 can send the information (the facility use information, the service providing information) which contributes to the information to be provided to the outside by the information providing apparatus 5, to the information providing apparatus 5.

### The Second Preferred Embodiment

First, description will be made on a constitution of an information providing apparatus in accordance with the second preferred embodiment of the present invention.

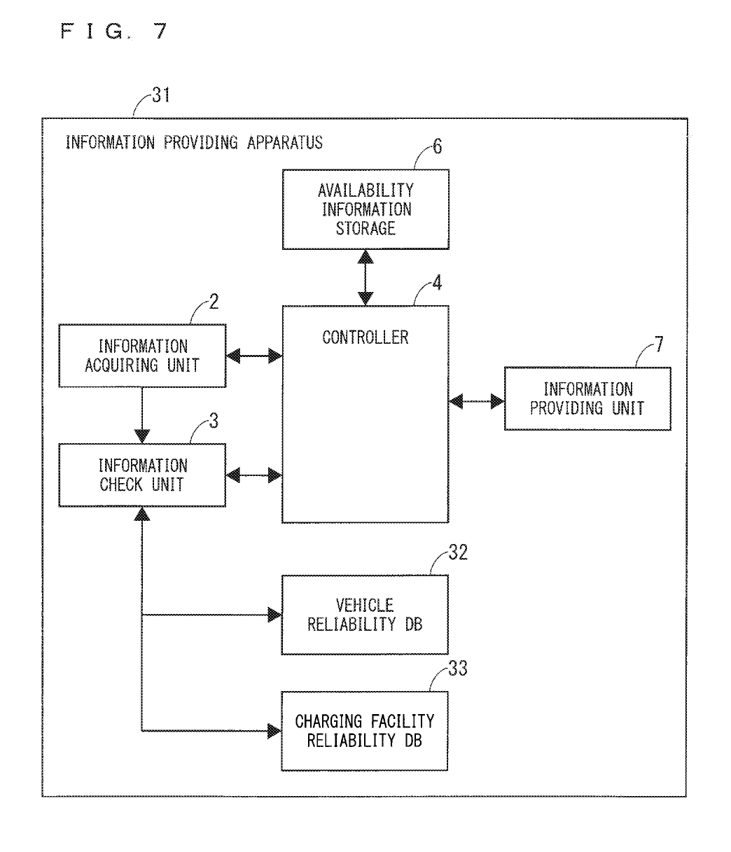

FIG. 7 is a block diagram showing an exemplary constitution of an information providing apparatus 31 in accordance with the second preferred embodiment.

As shown in FIG. 7, the information providing apparatus 31 of the second preferred embodiment comprises a vehicle reliability Data Base (DB) 32 and a charging facility reliability DB 33. Since constituent elements other than the above and the operations thereof are the same as those in the first preferred embodiment (see FIG. 2), description thereof will be omitted herein.

The vehicle reliability DB 32 accumulates the degree of reliability of the facility use information for each vehicle. The vehicle reliability DB 32 is a memory device, such as a Hard Disk Drive (HDD), a semiconductor memory, or the like. Specifically, the information check unit 3 calculates the degree of reliability on the basis of the facility use information which was not adopted as a result of the past check, and accumulates the degree of reliability in the vehicle reliability DB 32. In other words, the information check unit 3 calculates the degree of reliability of the facility use information for each vehicle on the basis of a history of the facility use information. The degree of reliability of the facility use information refers to the degree of reliability as an information source of each vehicle.

Further, the history of the facility use information may be accumulated in the vehicle reliability DB 32 or may be accumulated in other storage (not shown). As the above-described facility use information which was not adopted, the facility use information whose certainty was determined to be low because of low degree of coincidence with the service providing information and was not stored in the availability information storage 6 may be used, or the facility use information which was determined to be an error as a result of the check on the facility use information by a management company of the information providing apparatus 31 or the like may be used.

Herein, the degree of reliability of the facility use information may be the number of pieces of facility use information which were not adopted (the number of pieces of facility use information which are inconsistent with actual information). Further, the degree of reliability of the facility use information may be the number of pieces of facility use information which have not been adopted for a certain period (e.g., for several months or one year) (the frequency in the number of pieces of facility use information which are inconsistent with actual information). Furthermore, the degree of reliability of the facility use information may be the number of pieces of facility use information which have not been adopted out of the facility use information which have been acquired so far (the rate in the number of pieces of facility use information which are inconsistent with actual information).

Further, as to the degree of reliability of the facility use information, for example, when the number of, the frequency of, or the rate of pieces of facility use information which are inconsistent is not smaller than a predetermined threshold value, the degree of reliability of the facility use information may be determined to be low, and when smaller than the predetermined threshold value, the degree of reliability of the facility use information may be determined to be high.

The charging facility reliability DB 33 accumulates the degree of reliability of the service providing information for each charging facility. Specifically, the information check unit 3 calculates the degree of reliability on the basis of the service providing information which was not adopted as a result of the past check, and accumulates the degree of reliability in the charging facility reliability DB 33. In other words, the information check unit 3 calculates the degree of reliability of the service providing information for each facility on the basis of a history of the service providing information. The degree of reliability of the service providing information refers to the degree of reliability as an information source of each charging facility.

Further, the history of the service providing information may be accumulated in the charging facility reliability DB 33 or may be accumulated in other storage (not shown). As the above-described service providing information which was not adopted, the service providing information whose certainty was determined to be low because of low degree of coincidence with the facility use information and was not stored in the availability information storage 6 may be used, or the service providing information which was determined to be an error as a result of the check on the service providing information by the management company of the information providing apparatus 31 or the like may be used.

Herein, the degree of reliability of the service providing information may be the number of pieces of service providing information which were not adopted (the number of pieces of service providing information which are inconsistent with actual information). Further, the degree of reliability of the service providing information may be the number of pieces of service providing information which have not been adopted for a certain period (e.g., for several months or one year) (the frequency in the number of pieces of service providing information which are inconsistent with actual information). Furthermore, the degree of reliability of the service providing information may be the number of pieces of service providing information which have not been adopted out of the service providing information which have been acquired so far (the rate in the number of pieces of service providing information which are inconsistent with actual information).

Further, as to the degree of reliability of the service providing information, for example, when the number of, the frequency of, or the rate of pieces of service providing information which are inconsistent is not smaller than a predetermined threshold value, the degree of reliability of the service providing information may be determined to be low, and when smaller than the predetermined threshold value, the degree of reliability of the service providing information may be determined to be high.

When the information check unit 3 checks the facility use information with the service providing information, both of which are acquired by the information acquiring unit 2, the information check unit 3 calculates the certainty in accordance with the degree of coincidence between the facility use information and the service providing information which are acquired by the information acquiring unit 2, in consideration of the degree of reliability of the facility use information accumulated in the vehicle reliability DB 32 and the degree of reliability of the service providing information accumulated in the charging facility reliability DB 33.

Next, an operation of the information providing apparatus 31 will be described.

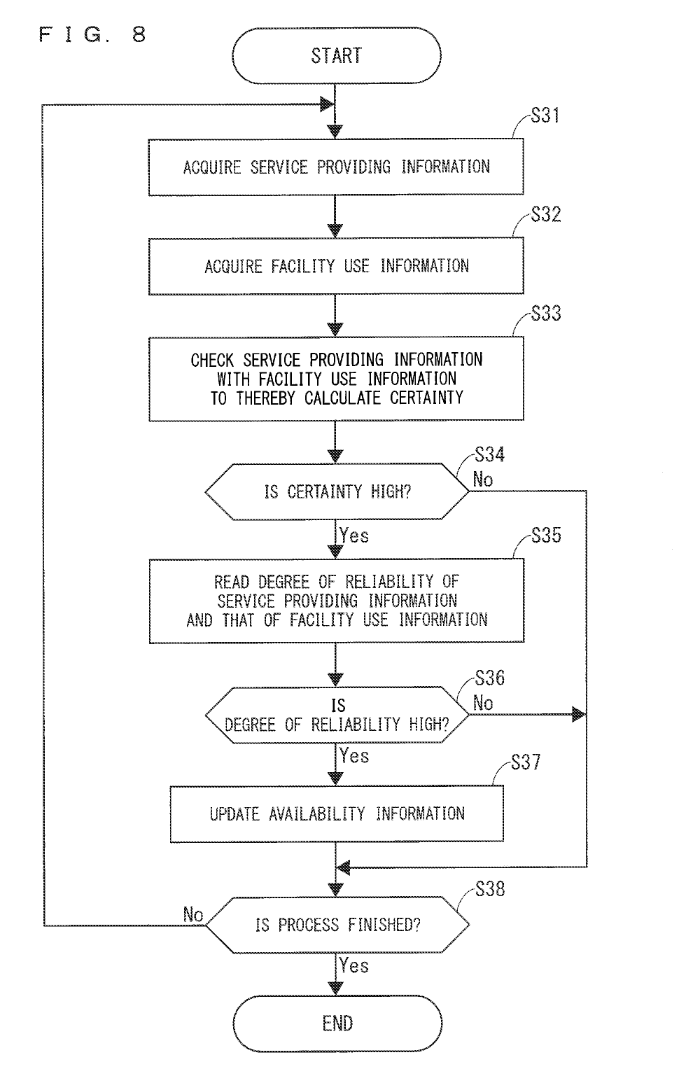

FIG. 8 is a flowchart showing an exemplary operation of the information providing apparatus 31. Further, since Steps S31 to S34, S37, and S38 in FIG. 8 correspond to Steps S11 to S16 in FIG. 3, description thereof will be omitted herein.

In Step S35, the information check unit 3 reads the degree of reliability of the service providing information from the charging facility reliability DB 33 and also reads the degree of reliability of the facility use information from the vehicle reliability DB 32.

In Step S36, the information check unit 3 determines whether the degree of reliability between the degree of reliability of the facility use information accumulated in the vehicle reliability DB 32 and the degree of reliability of the service providing information accumulated in the charging facility reliability DB 33 is high or not. When the degree of reliability is high, the process goes to Step S37. On the other hand, the degree of reliability is not high, the process goes to Step S38.

Herein, as to the above determination on whether the degree of reliability is high or not, for example, the degree of reliability may be determined to be high only when both the degree of reliability of the facility use information and that of the service providing information are not smaller than the predetermined threshold value, or the degree of reliability may be determined to be high when at least one of the degree of reliability of the facility use information and that of the service providing information is not smaller than the predetermined threshold value.

Specifically, for example, assuming that the degree of reliability of the service providing information of a charging facility i is RA(i) and the degree of reliability of the facility use information of a vehicle j is RB(j), it is determined whether the degree of reliability is high or not by adopting any one of (Example 1) to (Example 4) or by combining (Example 1) to (Example 4) as appropriate.

(Example 1) when RA(i)≧RAth and RB(j)≧RAth, the degree of reliability is determined to be high. Herein, RAth and RBth are threshold values for determining whether the degree of reliability is high or not.

(Example 2) when RA(i)≧RAth or RB(j)≧RAth, the degree of reliability is determined to be high. Herein, RAth and RBth are threshold values for determining whether the degree of reliability is high or not.

(Example 3) when RA(i)+RB(j)≧RABth, the degree of reliability is determined to be high. Herein, RABth is a threshold value for determining whether the degree of reliability is high or not.

(Example 4) when RA(i)<RAth2 or RB(j)<RBth2, the degree of reliability is determined to be low. In (Example 4), assumed is a case where either one of RA(i) and RB(j) is extremely low. Further, it is desirable that RAth>RAth2, RBth>RBth2.

Furthermore, though the availability information is updated when both the “certainty” and the “degree of reliability” are high in FIG. 8, this is only one exemplary case. When the degree of reliability on the vehicle side is extremely high, for example, the availability information may be updated in accordance with the information on the vehicle side even when the certainty is low.

Thus, according to the second preferred embodiment, it is possible to store the availability information with higher reliability than that in the first preferred embodiment.

### The Third Preferred Embodiment

In the third preferred embodiment of the present invention, description will be made on the degree of reliability of the availability information stored in the availability information storage 6. Further, since the constituent elements and the operation of an information providing apparatus of the third preferred embodiment are the same as those in the first and second preferred embodiments (see FIGS. 2 and 7), description thereof will be omitted herein.

As described earlier, the availability information includes information on the new-establishment of the charging facility, the in-service of the charging facility, the out-of-service of the charging facility, and the out-of-business of the charging facility, and these information change with time. Therefore, it is desirable that the availability information with high reliability should be stored in the availability information storage 6. Hereinafter, the reliability refers to the reliability of estimation on the new-establishment of the charging facility, the in-service of the charging facility, the out-of-service of the charging facility, and the out-of-business of the charging facility.

In the third preferred embodiment, in the availability information storage 6, accumulated are histories of facility information which are checked by the information check unit 3 and determined to have high certainty, besides the availability information.

The controller 4 performs a determination on the new-establishment of the charging facility, the in-service of the charging facility, the out-of-service of the charging facility, and the out-of-business of the charging facility (more specifically, performs an estimation on the degree of reliability on the new-establishment of the charging facility, the in-service of the charging facility, the out-of-service of the charging facility, and the out-of-business of the charging facility).

Next, the determinations on the new-establishment of the charging facility, the in-service of the charging facility, the out-of-service of the charging facility, and the out-of-business of the charging facility will be described one by one.

First, described will be the determination on the new-establishment of the charging facility.

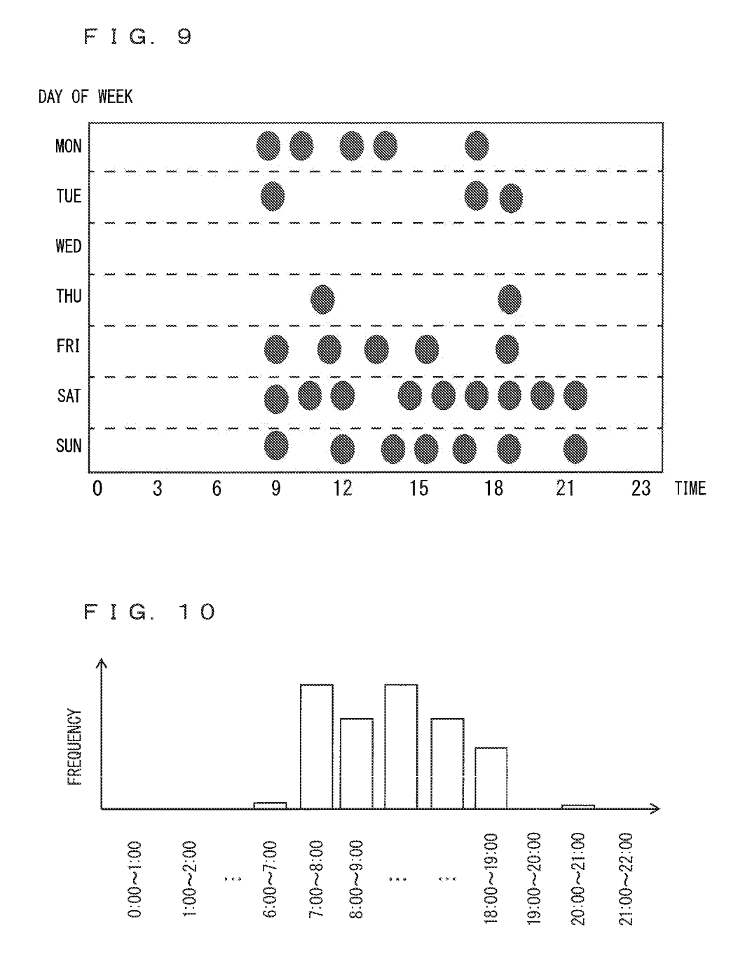

FIG. 9 is a graph for explaining the estimation on the new-establishment of the charging facility, and shows a case where a charging facility is newly established. In FIG. 9, the horizontal axis represents a time, and the vertical axis represents a day of week. Further, a solid (black) circle in this figure represents a vehicle which has used the charging facility two times or more, and one solid circle corresponds to one vehicle.

As shown in FIG. 9, when the number of vehicles each of which has used the same charging facility two times or more in a week increases, for example, it is determined that the charging facility has been newly established and the degree of reliability thereon is high. Though determination is made on the basis of the number of vehicles each of which has used the charging facility two times or more (i.e., the number of regular customers) herein, this is only one exemplary case.

Thus, when the controller 4 estimates that the degree of reliability on the new-establishment of the charging facility is high on the basis of the history of the facility use information, the controller 4 updates the availability information stored in the availability information storage 6. Therefore, the availability information with high reliability is stored in the availability information storage 6.

Next, described will be the determination on the in-service of the charging facility.

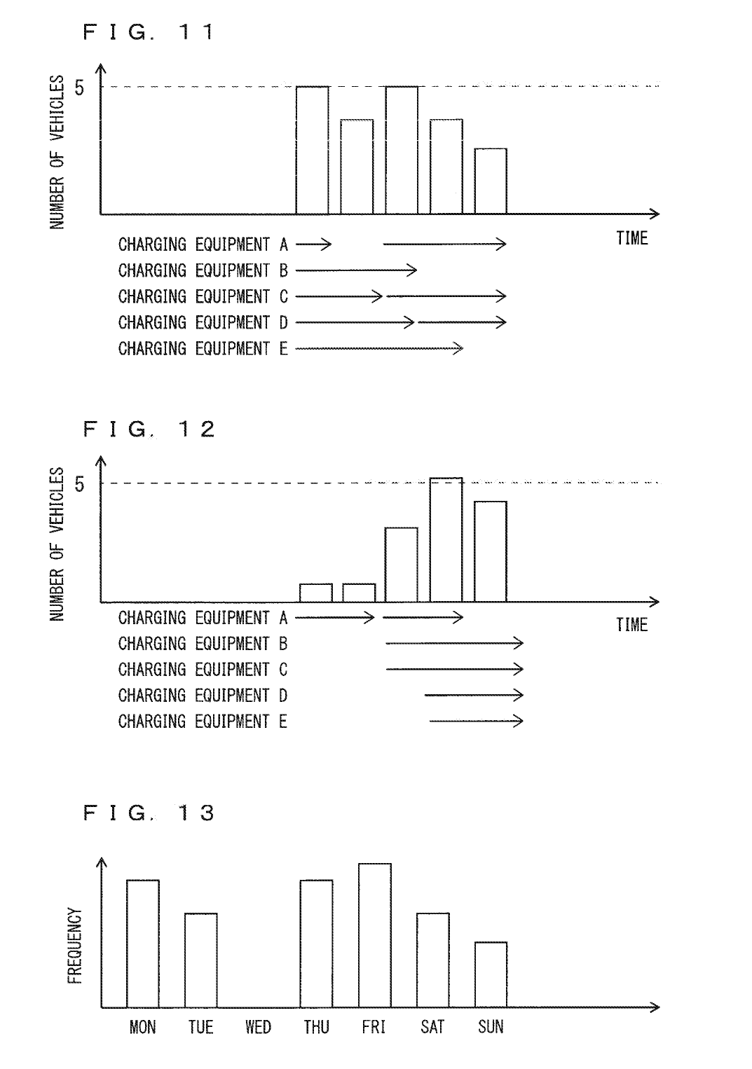

FIG. 10 is a graph for explaining the estimation on the in-service of the charging facility, and shows an availability state of a charging facility. In FIG. 10, the horizontal axis represents a time zone, and the vertical axis represents a frequency at which the vehicle uses the charging facility.

As shown in FIG. 10, for example, it can be seen that the frequency of use is high in the time zone of 7 o'clock to 19 o'clock among all the time zones. From this point, it is estimated that the business hours of the charging facility may be from 7 o'clock to 19 o'clock (in other words, the charging facility is available from 7 o'clock to 19 o'clock) and the degree of reliability thereon is determined to be high.

FIGS. 11 and 12 are graphs showing other examples for explaining the estimation of the in-service of the charging facility, and show respective use conditions of the same charging facility on different days. In FIGS. 11 and 12, the horizontal axis represents a time, and the vertical axis represents the number of vehicles which use the charging facility. Further, in FIGS. 11 and 12, it is assumed that the charging facility is provided with five charging equipments (charging equipments A to E), and each arrow represents a vehicle which uses the charging equipment. One arrow corresponds to one vehicle, and the length of the arrow indicates the length of time (corresponding to the time in the horizontal axis).

As shown in FIGS. 11 and 12, when the maximum number of vehicles which use the charging facility in the same time zone is five on the basis of the use conditions of the same charging facility on a plurality of days, it is estimated that five charging equipments are provided in the charging facility, and it is determined that the degree of reliability thereon is high. In other words, the time zone in which the charging facility is available and the number of charging equipments available in the charging facility can be estimated.

Thus, when the controller 4 estimates that the degree of reliability on the in-service of the charging facility is high on the basis of the history of the facility use information, the controller 4 updates the availability information stored in the availability information storage 6. Therefore, the availability information with high reliability is stored in the availability information storage 6.

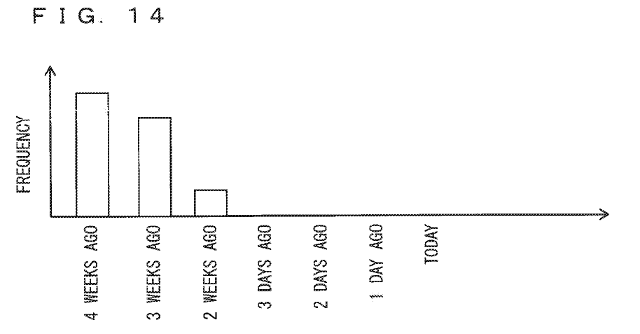

FIG. 13 is a graph for explaining the estimation on the out-of-service of the charging facility, and shows an availability state of a charging facility. In FIG. 13, the horizontal axis represents a day of week, and the vertical axis represents a frequency at which the vehicle uses the charging facility.

As shown in FIG. 13, for example, it can be seen that the charging facility is not used on Wednesday among all the days of week. From this point, it is estimated that the regular holiday of the charging facility is Wednesday (in other words, the charging facility is out of service on Wednesday), and it is determined that the degree of reliability thereon is high.

Thus, when the controller 4 estimates that the degree of reliability on the out-of-service of the charging facility is high on the basis of the history of the facility use information, the controller 4 updates the availability information stored in the availability information storage 6. Therefore, the availability information with high reliability is stored in the availability information storage 6.

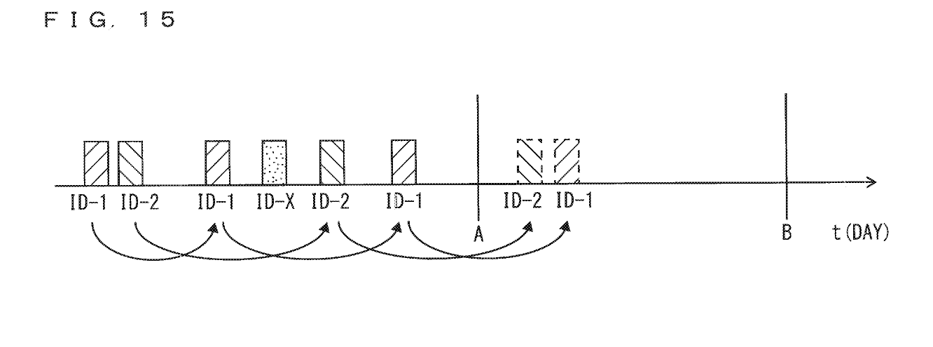

FIG. 14 is a view for explaining the estimation on the out-of-business of the charging facility, and shows an availability state of a charging facility. In FIG. 14, the horizontal axis represents a lapse of time, and the vertical axis represents a frequency at which the vehicle uses the charging facility.

As shown in FIG. 14, when the charging facility has not been used in the past year with “today” as a reference, for example, it is estimated that the charging facility is out of business, and it is determined that the degree of reliability thereon is high.

FIG. 15 is a view showing another example for explaining the degree of reliability on the out-of-business of the charging facility. In FIG. 15, the horizontal axis represents a lapse of time.

The controller 4 selects a plurality of vehicles which regularly use the charging facility and obtains an average of intervals (average use interval) at which each vehicle uses the charging facility for a certain period (e.g., for three months) in the past. Then, the controller 4 performs the estimation on the out-of-business on the basis of a ratio of the number of vehicles which actually use the charging facility to the number of vehicles which plan to use the charging facility on a day (or several days including the day) on which it is estimated from the average use interval of each vehicle that the vehicle will use the charging facility next.

As shown in FIG. 15, in a case where a vehicle (ID-1) and another vehicle (ID-2) regularly use a charging facility, for example, though respective days on which the vehicle (ID-1) and the vehicle (ID-2) will use the charging facility after the day A are estimated, the vehicles do not actually use the charging facility. Further, from the day A to the day B (e.g., the present time), there is no vehicle which uses the charging facility.

Thus, when the number of vehicles which use the charging facility on the estimated day decreases (or there is no vehicle which uses the charging facility after that), it is estimated that the charging facility went out of business and it is determined that the degree of reliability thereon is high.

Further, though it is determined herein from the use conditions of the vehicles (i.e., the regular customers) which regularly use the charging facility, not including the vehicles (ID-X) which use only once, this is only one exemplary case.

Furthermore, when only a few vehicles usually use the charging facility, the above average use interval may be set longer. In other words, the controller 4 may perform the determination on the out-of-business of the charging facility on the basis of the frequency at which the vehicles use the charging facility.

Thus, when the controller 4 estimates that the degree of reliability on the out-of-business of the charging facility is high on the basis of the history of the facility use information, the controller 4 updates the availability information stored in the availability information storage 6. Therefore, the availability information with high reliability is stored in the availability information storage 6.

Thus, according to the third preferred embodiment, since the controller 4 determines the new-establishment of the charging facility, the in-service of the charging facility, the out-of-service of the charging facility, and the out-of-business of the charging facility, it is possible to store the availability information with high reliability in the availability information storage 6.

### The Fourth Preferred Embodiment

In the third preferred embodiment, the case where the controller 4 determines the new-establishment of the charging facility, the in-service of the charging facility, the out-of-service of the charging facility, and the out-of-business of the charging facility has been described. In the fourth preferred embodiment of the present invention, described will be a case where confirmation on the new-establishment of the charging facility, the in-service of the charging facility, the out-of-service of the charging facility, and the out-of-business of the charging facility is requested to the outside.

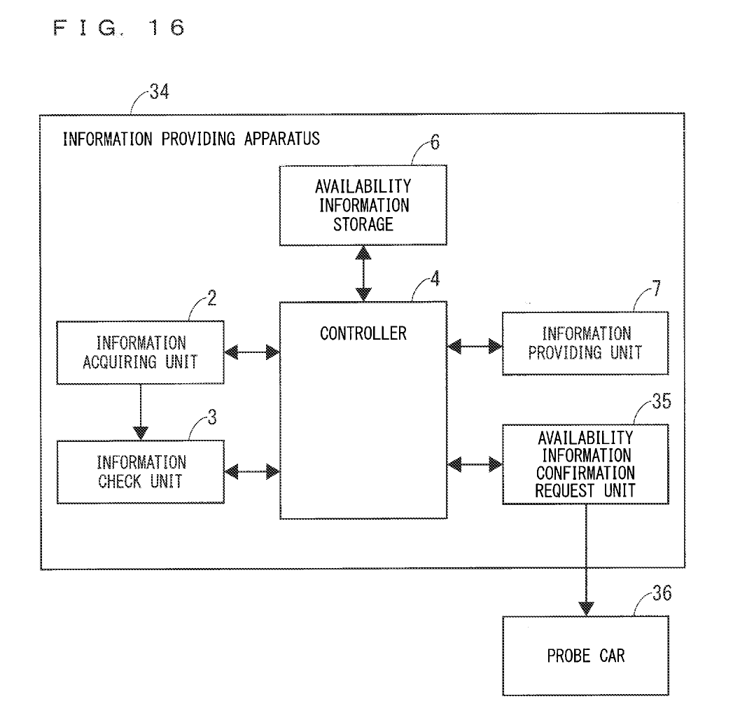

FIG. 16 is a block diagram showing an exemplary constitution of an information providing apparatus 34 in accordance with the fourth preferred embodiment.

As shown in FIG. 16, the information providing apparatus 34 comprises an availability information confirmation request unit 35. Since constituent elements other than the above are the same as those in the first preferred embodiment (see FIG. 2), description thereof will be omitted herein.

The availability information confirmation request unit 35 requests a probe car 36 on the outside to confirm the availability information stored in the availability information storage 6.

When the probe car 36 confirms the availability information in response to the request, the probe car 36 sends a confirmation result to the information providing apparatus 34. When the information providing apparatus 34 acquires the confirmation result from the probe car 36, the controller 4 performs a determination on the new-establishment of the charging facility, the in-service of the charging facility, the out-of-service of the charging facility, and the out-of-business of the charging facility on the basis of the confirmation result.

Further, the probe car 36 may be a vehicle registered in advance, may be a vehicle which is located around the target charging facility, or may be a vehicle which is located around the target charging facility and registered in advance.

Further, in the information providing apparatus 34, the confirmation result from the probe car 36 may be acquired by the information acquiring unit 2 or acquired by the availability information confirmation request unit 35.

Next, an operation of the information providing apparatus 34 will be described.

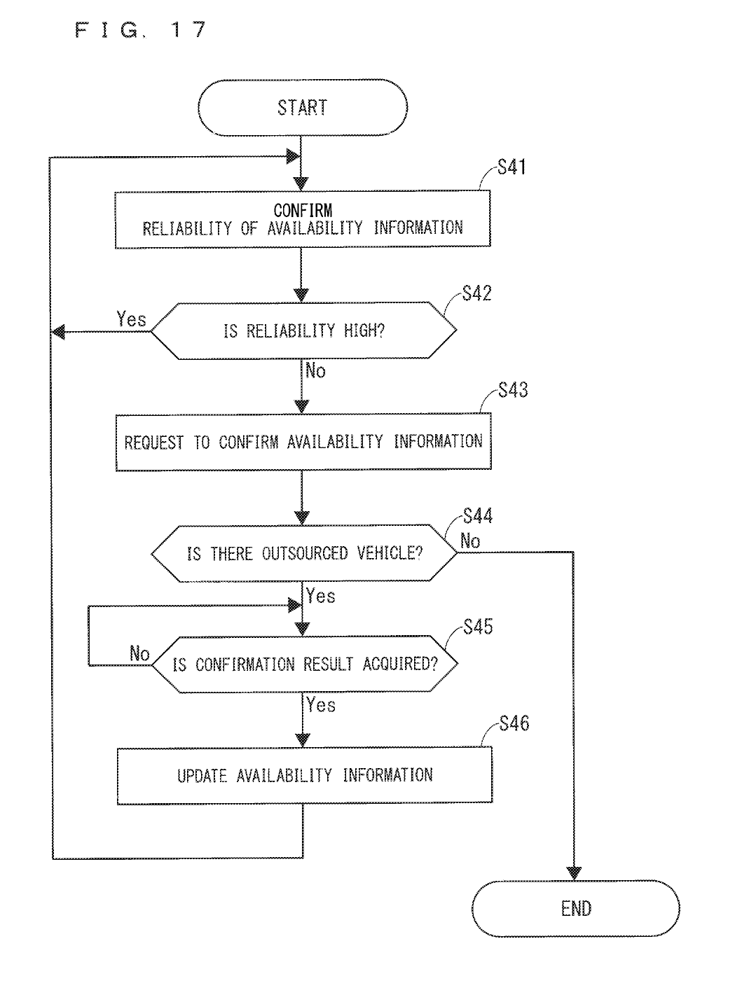

FIG. 17 is a flowchart showing an exemplary operation of the information providing apparatus 34.

In Step S41, the controller 4 confirms the degree of reliability of the availability information stored in the availability information storage 6.

In Step S42, the controller 4 determines whether the degree of reliability of the availability information is high or not. Specifically, the controller 4 determines whether the degree of reliability of the availability information is high or not by using the method described in the third preferred embodiment. When the degree of reliability of the availability information is high, the process goes to Step S41. On the other hand, when the degree of reliability of the availability information is not high, the process goes to Step S43.

In Step S43, the availability information confirmation request unit 35 requests the probe car 36 to confirm the availability information. Prior to the confirmation request, the controller 4 selects, for example, a probe car 36 which is located around the target charging facility and registered in advance.

In Step S44, the availability information confirmation request unit 35 determines whether or not there is a probe car (outsourced vehicle) 36 to which the confirmation request is outsourced. When there is an outsourced probe car 36, the process goes to Step S45. On the other hand, there is no outsourced probe car 36, the process is finished. Further, when there is an outsourced probe car 36, the availability information confirmation request unit 35 sends the position information of at least the target charging facility to the probe car 36.

In Step S45, the information acquiring unit 2 waits for acquiring the confirmation result from the probe car 36, and when the information acquiring unit 2 acquires the confirmation result, the process goes to Step S46.

In Step S46, the controller 4 performs a determination on the new-establishment of the charging facility, the in-service of the charging facility, the out-of-service of the charging facility, and the out-of-business of the charging facility on the basis of the confirmation result acquired by the information acquiring unit 2, and updates the availability information stored in the availability information storage 6. Further, after the controller 4 performs a determination on the basis of the above confirmation result, the controller 4 may give an incentive to the probe car 36 (the sender of the confirmation result). As the incentive, for example, a point which can be used for payment for the charge in the charging facility, or the like, may be adopted.

Next, described will be an operation of the probe car 36.

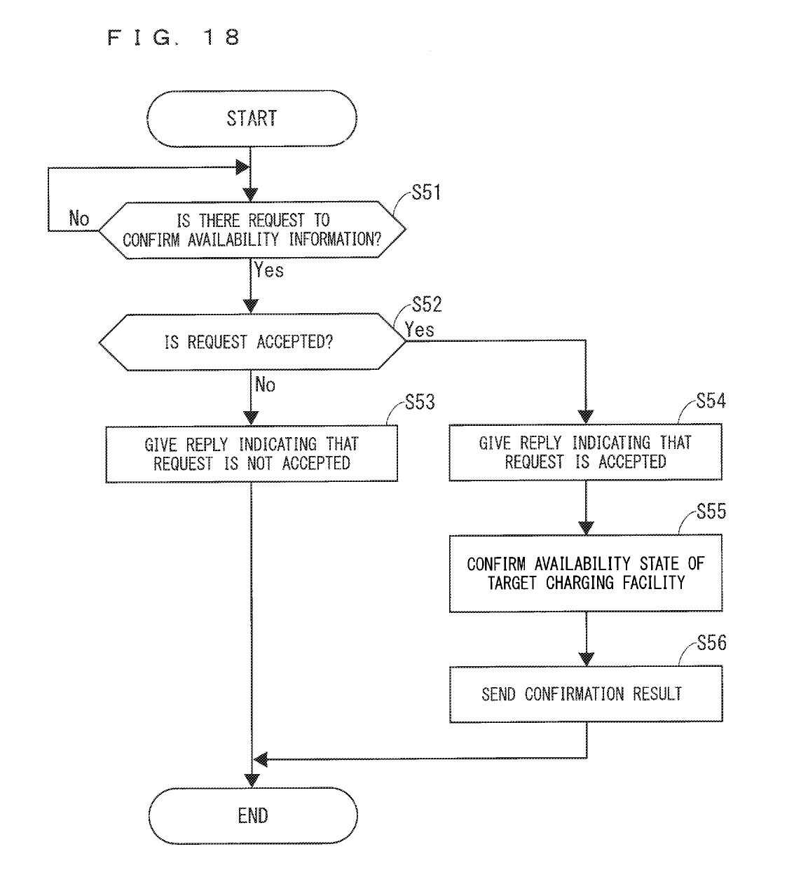

FIG. 18 is a flowchart showing an exemplary operation of the probe car 36.

In Step S51, when there is a request to confirm the availability information from the information providing apparatus 34, the process goes to Step S52.

In Step S52, it is determined whether the request should be accepted or not. When the request is not accepted, the process goes to Step S53. On the other hand, when the request is accepted, the process goes to Step S54.

In Step S53, a reply indicating that the request is not to be accepted is given to the information providing apparatus 34.

In Step S54, a reply indicating that the request is to be accepted is given to the information providing apparatus 34. At that time, the probe car 36 acquires the position information of at least the target charging facility from the information providing apparatus 34. When the probe car 36 is provided with a navigation function, it is possible to set the target charging facility as a destination on the basis of the position information of the charging facility which is acquired from the information providing apparatus 34.

In Step S55, the availability state of the target charging facility is confirmed.

In Step S56, the confirmation result is sent to the information providing apparatus 34. Further, there may be a case where the probe car 36 actually uses the charging facility and sends the facility use information, as the confirmation result, to the information providing apparatus 34. Furthermore, when there is no charging facility or the charging facility is out of business, the fact may be sent to the information providing apparatus 34 as the confirmation result. As the confirmation result, a picture of the charging facility may be sent to the information providing apparatus 34. Together with the picture of the charging facility, the position information of the probe car 36 which went to the charging facility may be also sent to the information providing apparatus 34 (in this case, these are evidences that the probe car 36 actually went to the charging facility).

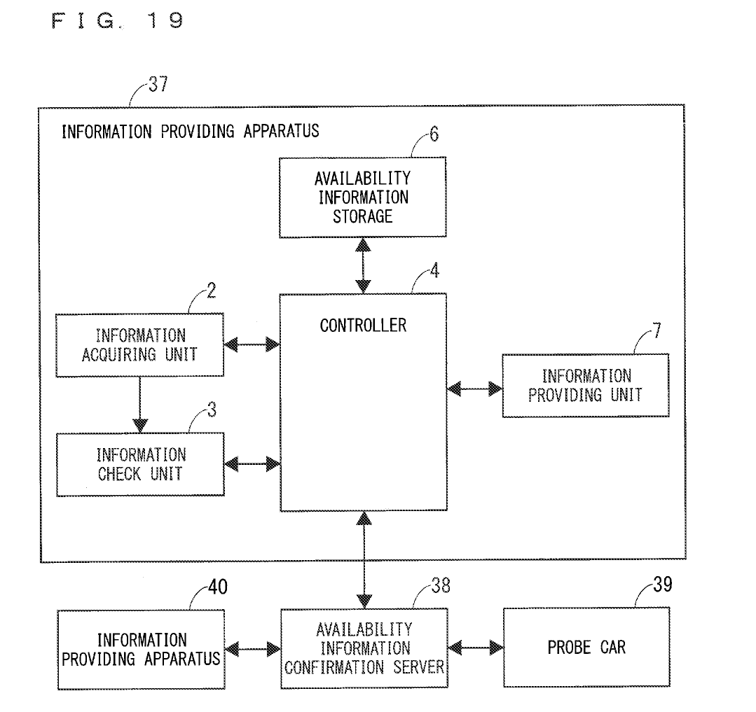

FIG. 19 is a block diagram showing an exemplary constitution of another exemplary information providing apparatus 37 in accordance with the fourth preferred embodiment. Since constituent elements of the information providing apparatus 37 are the same as those of the information providing apparatus 5 (see FIG. 2) in the first preferred embodiment, description thereof will be omitted herein.

As shown in FIG. 19, the information providing apparatus 37 is connected communicably to the availability information confirmation server 38 on the outside.

When the availability information confirmation server 38 receives a request to confirm the availability information from the information providing apparatus 37, the availability information confirmation server 38 confirms the availability state of the target charging facility by using the probe car 39 and sends the confirmation result to the information providing apparatus 37.

Further, when another information providing apparatus 40 has the availability state of the target charging facility, the availability information confirmation server 38 may acquire information on the availability state of the target charging facility from the information providing apparatus 40 and send the acquired information as the confirmation result to the information providing apparatus 37. Furthermore, it is assumed that the information providing apparatus 40 has the same function as that of the information providing apparatus 37 and the information providing apparatus 37 and the information providing apparatus 40 are operated by different companies.

Thus, according to the fourth preferred embodiment, also by requesting the outside to confirm the new-establishment of the charging facility, the in-service of the charging facility, the out-of-service of the charging facility, and the out-of-business of the charging facility, the same effect as that in the third preferred embodiment can be produced.

### The Fifth Preferred Embodiment

In the fifth preferred embodiment, description will be made on a display control device for acquiring the availability information stored in the availability information storage 6 (see FIGS. 2, 7, 16, and 19) of the first to fourth preferred embodiments, from the information providing apparatus, and performing a control to display information based on the acquired availability information, on a display device.

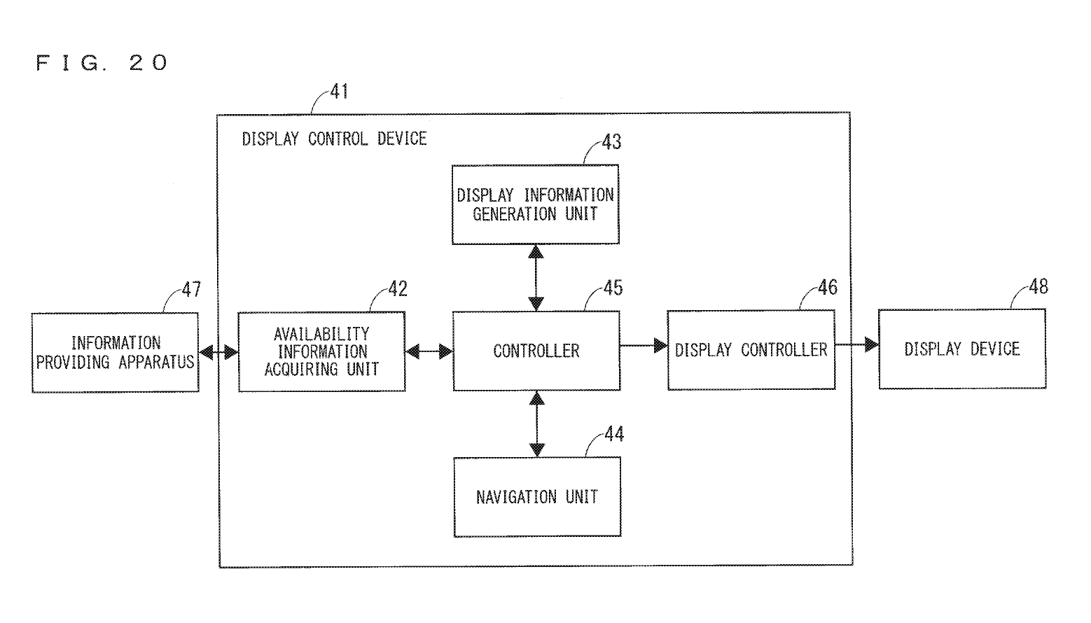

FIG. 20 is a block diagram showing an exemplary constitution of a display control device 41 in accordance with the fifth preferred embodiment. Hereinafter, though the following description will be made assuming that the display control device 41 is mounted on the vehicle, this is only one exemplary case.

As shown in FIG. 20, the display control device 41 comprises an availability information acquiring unit 42, a display information generation unit 43, a navigation unit 44, a controller 45, and a display controller 46.

The availability information acquiring unit 42 acquires the availability information from an information providing apparatus 47. Further, as a method of acquiring the availability information, the display control device 41 may request the information providing apparatus 47 to provide the availability information, or the information providing apparatus 47 may deliver the availability information to the display control device 41 which is located near the information providing apparatus 47.

The display information generation unit 43 generates information to be displayed on the display device 48, on the basis of the availability information acquired by the availability information acquiring unit 42.

On the basis of a destination that the user sets and a present location of the own-vehicle, the navigation unit 44 searches for a route from the present location to the destination. Further, it is assumed that the destination is set by an operation unit (not shown) and the present location of the own-vehicle is acquired by an own-vehicle position information acquiring unit (not shown).

The display controller 46 performs a control to display the information generated by the display information generation unit 43 and the route and the like searched out by the navigation unit 44, on the display device 48.

The controller 45 controls respective operations of the availability information acquiring unit 42, the display information generation unit 43, the navigation unit 44, and the display controller 46.

Next, described will be an exemplary display of the information to be displayed on the display device 48.

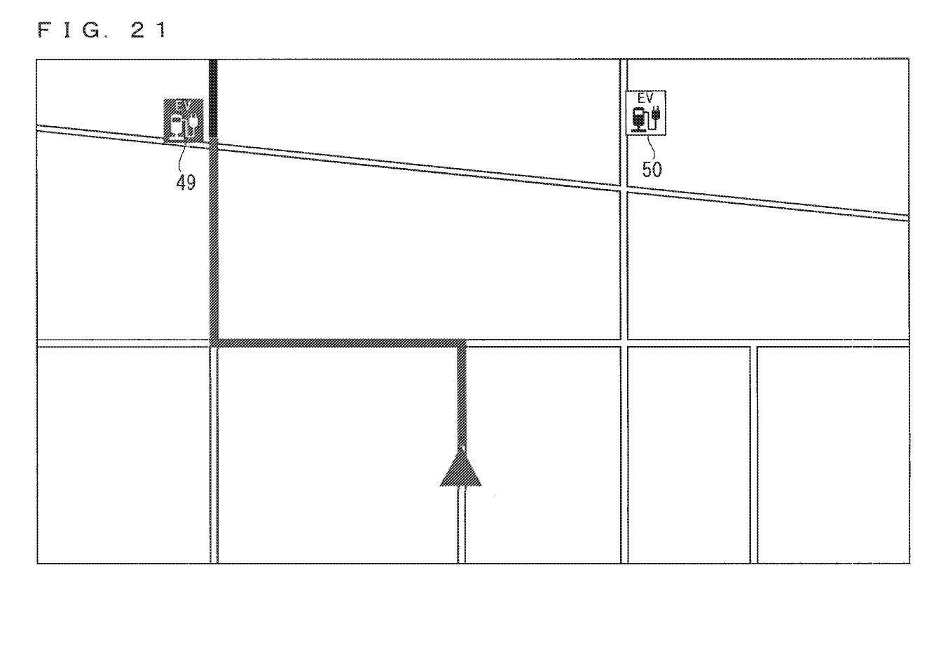

FIG. 21 is a view showing an exemplary display on the display device 48. In FIG. 21, a triangle mark represents the own-vehicle.

As shown in FIG. 21, on the map, displayed are respective icons of charging facilities 49 and 50. Further, the icon of the charging facility 49 indicates a charging facility having more actual achievements of charging, and the icon of the charging facility 50 indicates a charging facility having less actual achievements of charging. Furthermore, on the map, the route searched out by the navigation unit 44 is displayed.

The controller 45 determines whether the charging facility has more actual achievements of charging or less, on the basis of the availability information acquired by the availability information acquiring unit 42. Herein, the more or less of the actual achievement of charging is determined on the basis of the number of vehicles which use the charging facility per day, and for example, the charging facility used by vehicles not less than a predetermined number is determined to have more actual achievements of charging and the charging facility used by vehicles less than the predetermined number is determined to have less actual achievements of charging.

The display information generation unit 43 generates the respective icons of the charging facilities 49 and 50 to be displayed on the display device 48, in accordance with the more or less of the actual achievement of charging which is determined by the controller 45. Specifically, the display information generation unit 43 generates the icons so that the icon of the charging facility 49 having more actual achievements of charging should be more outstanding than that of the charging facility 50 having less actual achievements of charging. In FIG. 21, for example, the icon of the charging facility 49 may be green and that of the charging facility 50 may be gray.

The navigation unit 44 searches for the route from the present location to the destination on the basis of the more or less of the actual achievement of charging which is determined by the controller 45. Specifically, the navigation unit 44 searches for the route so as to reach the destination by way of the charging facility 49.

The display controller 46 controls the icons of the charging facilities 49 and 50, which are generated by the display information generation unit 43, and the route searched out by the navigation unit 44 to be displayed on the display device 48.

Further, in the above case, the timing at which the navigation unit 44 searches for the route by way of the charging facility 49 may be the time when the user sets the destination or the time when the own-vehicle needs charging.

Though the case where the charging facility is selected on the basis of the more or less of the actual achievement of charging has been described above, this is only one exemplary case. The charging facility may be selected on the basis of, for example, the electricity rate required for charging, the number of charging equipments provided in the charging facility, the congestion condition of the charging facility, the charging facility which the user often uses, or the like.

Though the case where the navigation unit 44 searches for the route has been described, there may be a case where the navigation unit 44 does not search for the route.

In this case, the display device 48 does not display the route thereon and displays only the icons of the charging facilities 49 and 50.

The availability information acquired by the availability information acquiring unit 42 may include such icons of the charging facilities 49 and 50 as shown in FIG. 21 and pictures.

The icons of the charging facilities 49 and 50 may not be distinguished by colors. For example, the icon of the charging facility 49 may be blinked.

FIG. 22 is a view showing an exemplary display in the display device 48. In FIG. 22, a triangle mark represents the own-vehicle.

As shown in FIG. 22, on the map, displayed are respective icons of charging facilities 51, 52 and 53. Further, the icons of the charging facilities 51 and 53 represent the charging facilities which are available when the own-vehicle arrives at the charging facilities 51 or 53, and the icon of the charging facility 52 represents the charging facility which is not available when the own-vehicle arrives at the charging facility 52. Furthermore, on the map, the route searched out by the navigation unit 44 is displayed.

The controller 45 determines whether the charging facility is available or not when the own-vehicle arrives at the charging facility, on the basis of the availability information acquired by the availability information acquiring unit 42. Herein, it is determined whether the charging facility is available or not, for example, from the business hours or the like of the charging facility included in the availability information.

As the time at which the own-vehicle arrives at each charging facility, an estimated arrival time from the present location to each charging facility, which is given by the navigation unit 44, may be used.

The display information generation unit 43 generates the icons of the charging facilities 51, 52, and 53 to be displayed on the display device 48 in accordance with the determination by the controller 45 on whether the charging facilities 51, 52, and 53 are available or not. Specifically, the display information generation unit 43 generates the icons so that the icons of the available charging facilities 51 and 53 should be more outstanding than that of the not-available charging facility 52. In FIG. 22, for example, the icons of the charging facilities 51 and 53 may be green and that of the charging facility 52 may be gray.

The navigation unit 44 searches for the route from the present location to the destination on the basis of the determination by the controller 45 on whether the charging facility is available or not. Specifically, the navigation unit 44 searches for the route so as to reach the destination by way of the charging facility 51 which is located on the way from the present location toward the destination, among the available charging facilities 51 and 53. At that time, the charging facility 53 is not selected (the route by way of the charging facility 53 is not adopted) since the charging facility 53 is available but the route to the destination by way of the charging facility 53 is a detour.

The display controller 46 controls the icons of the charging facilities 51, 52, and 53, which are generated by the display information generation unit 43, and the route searched out by the navigation unit 44 to be displayed on the display device 48.

Further, in the above case, the timing at which the navigation unit 44 searches for the route by way of the charging facility 51 may be the time when the user sets the destination or the time when the own-vehicle needs charging.

The availability information acquired by the availability information acquiring unit 42 may include such icons of the charging facilities 51, 52, and 53 as shown in FIG. 22 and pictures.

The icons of the charging facilities 51, 52, and 53 may not be distinguished by colors. For example, the icon of the charging facility 51 may be blinked.

Thus, according to the fifth preferred embodiment, the user can go to the charging facility which is surely in service with high efficiency.

The information providing apparatuses described above can be applied not only to an in-vehicle navigation device, i.e., a car navigation device but also to a navigation device configured as a system by appropriately combining a Portable Navigation Device (PND), a portable communication terminal (for example, a cellular phone, a smartphone, a tablet terminal, or the like), a server, and the like which are mountable on a vehicle, or an apparatus other than the navigation device. In this case, the functions or the constituent elements of the information providing apparatus are dispersed separately into the functions constituting the above system.

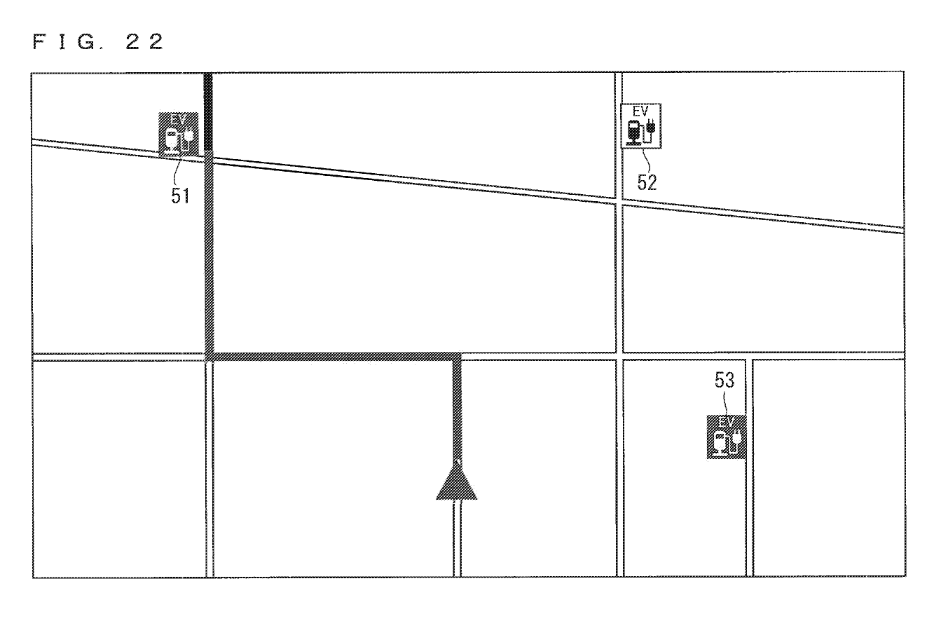

Specifically, as an example, the functions of the information providing apparatus can be arranged in a server. As shown in FIG. 23, for example, an information providing system which comprises a display device 55 on the user side and further comprises at least the information acquiring unit 2, the information check unit 3, and the controller 4 in a server 54 can be constructed. The functions of the information acquiring unit 2, the information check unit 3, and the controller 4 are the same as those of the information acquiring unit 2, the information check unit 3, and the controller 4 shown in FIG. 1. Further, the server 54 may comprise the constituent elements shown in FIGS. 2, 7, and 16 as necessary. At that time, the constituent elements included in the server 54 may be dispersed separately into the server 54 and the display device 55 as appropriate.

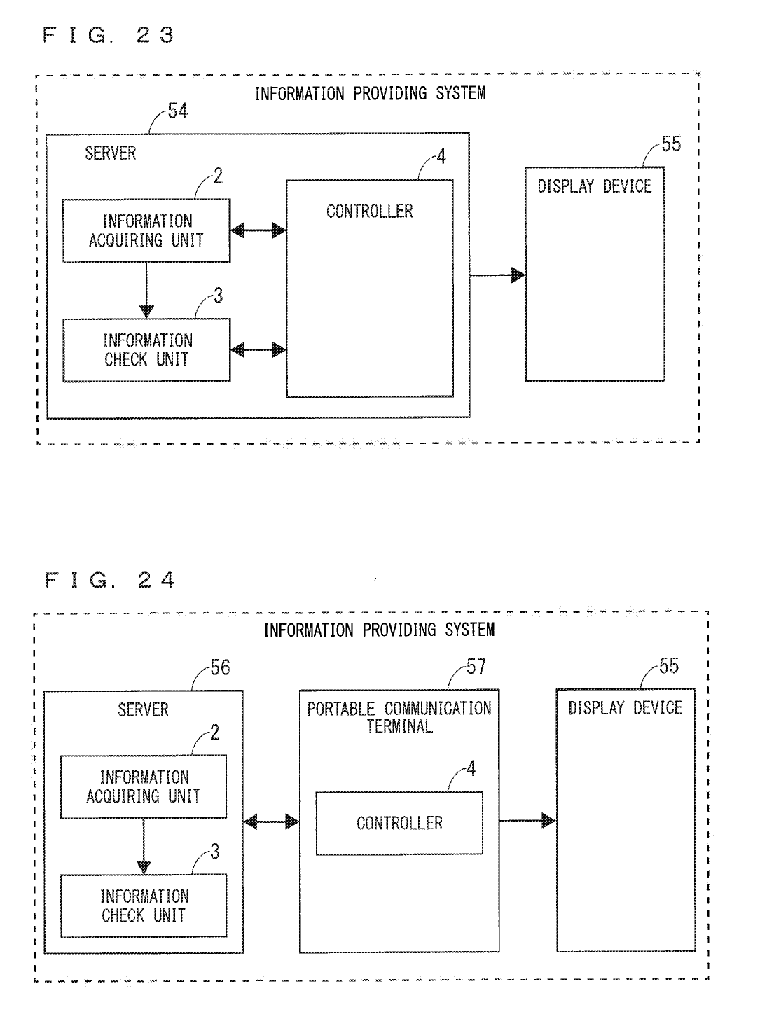

Further, as another example, the functions of the information providing apparatus can be arranged in a server and a portable communication terminal. As shown in FIG. 24, for example, an information providing system which comprises the display device 55 on the user side and further comprises at least the information acquiring unit 2 and the information check unit 3 in a server 56 and comprises the controller 4 in a portable communication terminal 57 can be constructed. The functions of the information acquiring unit 2, the information check unit 3, and the controller 4 are the same as those of the information acquiring unit 2, the information check unit 3, and the controller 4 shown in FIG. 1. Further, the server 56 and the portable communication terminal 57 may comprise the constituent elements shown in FIGS. 2, 7, and 16 as necessary. At that time, the constituent elements included in the server 56 and the portable communication terminal 57 may be dispersed separately into the display device 55, the server 56 and the portable communication terminal 57 as appropriate.

Even in a case of the above constitution, the same effects as those in the above-described preferred embodiments can be produced.

Further, a software (information providing method) for performing the operations in the above-described preferred embodiments may be incorporated in, for example, the server or the portable communication terminal.

Specifically, as an example, in the above information providing method, the facility use information indicating that a vehicle has used a facility and the service providing information indicating that the facility has provided the vehicle with a service are acquired, a check of the facility use information with the service providing information, both of which are acquired, is made, and the availability information indicating an availability state of the facility is updated on the basis of a result of the check.

From the above description, by incorporating the software for performing the operations in the above-described preferred embodiments into the server or the portable communication terminal and executing the software, the same effects as those in the above-described preferred embodiments can be produced.

In FIGS. 1, 2, 5 to 7, 16, 19, 20, 23, and 24, each of the information acquiring unit 2, the information check unit 3, the controller 4, the information providing unit 7, the communication units 9 and 11, the power supply unit 13, the feed controller 14, the power receiving unit 20, the power controller 23, the operation input unit 24, the display output unit 25, the communication unit 26, the position information acquiring unit 27, the communication unit 29, the availability information confirmation request unit 35, the availability information acquiring unit 42, the display information generation unit 43, the navigation unit 44, the controller 45, and the display controller 46 is implemented by executing a program processing on the basis of the software by using a Central Processing Unit (CPU). Further, if possible, each of the information acquiring unit 2, the information check unit 3, the controller 4, the information providing unit 7, the communication units 9 and 11, the power supply unit 13, the feed controller 14, the power receiving unit 20, the power controller 23, the operation input unit 24, the display output unit 25, the communication unit 26, the position information acquiring unit 27, the communication unit 29, the availability information confirmation request unit 35, the availability information acquiring unit 42, the display information generation unit 43, the navigation unit 44, the controller 45, and the display controller 46 may be configured as hardware (for example, as an arithmetic/processing circuit or the like to perform a specific computation or processing on an electrical signal). Furthermore, both the above two types may be mixed.

Though the charging facility is taken as an example in the first to fifth preferred embodiments, the facility is not limited to this but may be any facility only if the vehicle is communicable with the facility and the vehicle (driver) can use the facility.

In the present invention, the preferred embodiments may be freely combined, or may be changed or omitted as appropriate, without departing from the scope of the invention.

While the invention has been shown and described in detail, the foregoing description is in all aspects illustrative and not restrictive. It is therefore understood that numerous modifications and variations can be devised without departing from the scope of the invention.

### DESCRIPTION OF REFERENCE NUMERALS

1 information providing apparatus, 2 information acquiring unit, 3 information check unit, 4 controller, 5 information providing apparatus, 6 availability information storage, 7 information providing unit, 8 charging facility, 9 communication unit, 10 charging facility profile storage, 11 communication unit, 12 power source, 13 power supply unit, 14 feed controller, 15 general controller, 16 vehicle, 17 operation unit, 18 display, 19 information equipment, 20 power receiving unit, 21 battery, 22 drive motor, 23 power controller, 24 operation input unit, 25 display output unit, 26 communication unit, 27 position information acquiring unit, 28 vehicle profile storage, 29 communication unit, 30 general controller, 31 information providing apparatus, 32 vehicle reliability DB, 33 charging facility reliability DB, 34 information providing apparatus, 35 availability information confirmation request unit, 36 probe car, 37 information providing apparatus, 38 availability information confirmation server, 39 probe car, 40 information providing apparatus, 41 display control device, 42 availability information acquiring unit, 43 display information generation unit, 44 navigation unit, 45 controller, 46 display controller, 47 information providing apparatus, 48 display device, 49 to 53 charging facility icon, 54 server, 55 display device, 56 server, 57 portable communication terminal.

1-22. (canceled)

23. An information providing system, comprising:
a processor to execute a program; and
a memory to store the program which, when executed by said processor, performs processes of:
acquiring facility use information indicating that a vehicle has used a facility and service providing information indicating that said facility has provided said vehicle with a service;
checking said facility use information with said service providing information, both of which are acquired in said acquiring; and
updating availability information indicating an availability state of said facility on the basis of a check result obtained in said checking,
wherein said checking includes checking said facility use information with said service providing information on a one-to-one basis.

24. The information providing system according to claim 23, wherein
said checking includes calculating a certainty of said facility use information and said service providing information by checking said facility use information with said service providing information, and
said updating includes updating said availability information on the basis of said certainty calculated in said calculating.

25. The information providing system according to claim 24, wherein
said calculating includes calculating said certainty on the basis of a degree of coincidence of said facility use information and said service providing information.

26. The information providing system according to claim 24, wherein
when fee transferring information indicating that an electronic fee has been transferred between said vehicle and said facility is acquired from at least one of said vehicle and said facility in said acquiring,
said certainty is calculated in said calculating on the basis of said fee transferring information.

27. The information providing system according to claim 23, wherein
said checking includes calculating a degree of reliability of said facility use information for each said vehicle on the basis of a history of said facility use information,
said updating includes updating said availability information on the basis of said degree of reliability of said facility use information calculated in said calculating,
said checking includes calculating a degree of reliability of said service providing information for each said facility on the basis of a history of said service providing information, and
said updating includes updating said availability information on the basis of said degree of reliability of said service providing information calculated in said calculating.

28. The information providing system according to claim 23, wherein
said processor further performs a process of requesting a confirmation of said availability information,
when a result of said confirmation is acquired in said acquiring, a determination is made in said updating on new-establishment of said facility, in-service of said facility, out-of-service of said facility, or out-of-business of said facility on the basis of said result, and
said updating includes making said determination on the basis of said facility use information indicating that a sender of said result of said confirmation has used said facility.

29. The information providing system according to claim 28, wherein
when said determination is made in said making, an incentive is given to said sender of said result of said confirmation.

30. The information providing system according to claim 23, wherein
said acquiring includes acquiring said facility use information and said service providing information from said vehicle or a communication terminal communicable with said vehicle.

31. The information providing system according to claim 23, wherein
said acquiring includes acquiring said facility use information and said service providing information from said facility or a communication terminal communicable with said facility.

32. The information providing system according to claim 23, wherein
said acquiring includes acquiring said facility use information and said service providing information from a communication terminal communicable with said vehicle and said facility.

33. The information providing system according to claim 23, wherein
said acquiring includes acquiring said facility use information from said vehicle or a first communication terminal communicable with said vehicle, and acquiring said service providing information from said facility or a second communication terminal communicable with said facility.

34. The information providing system according to claim 23, wherein
said service providing information includes a service providing time, a provided service content, and information specifying said facility.

35. The information providing system according to claim 34, wherein
said information specifying said facility includes a name of said facility, an ID of said facility, and position information of said facility.

36. The information providing system according to claim 23, wherein
said facility use information includes a use time of said facility, a service content provided by said facility, information specifying said facility, and specific information of said vehicle.

37. The information providing system according to claim 36, wherein
said information specifying said facility includes a name of said facility, an ID of said facility, position information of said facility, and position information of said vehicle at a time when said vehicle has used said facility.

38. The information providing system according to claim 23, wherein
said updating includes making a determination on new-establishment of said facility, in-service of said facility, out-of-service of said facility, or out-of-business of said facility on the basis of a history of said facility use information.

39. The information providing system according to claim 23, wherein
said updating includes estimating a degree of reliability on new-establishment of said facility, in-service of said facility, out-of-service of said facility, or out-of-business of said facility on the basis of a history of said facility use information.

40. The information providing system according to claim 38, wherein
said updating includes making a determination on said out-of-business of said facility on the basis of a frequency at which said vehicle uses said facility.

41. The information providing system according to claim 23, wherein
said processor further performs a process of providing said availability information.

42. The information providing system according to claim 25, wherein
said degree of coincidence has a predetermined acceptable range.

43. The information providing system according to claim 23, wherein
said availability information includes new-establishment of said facility, out-of-service of said facility, and out-of-business of said facility.

44. The information providing system according to claim 27, wherein
when said degree of reliability of said service providing information is not smaller than a first threshold value and said degree of reliability of said facility use information is not smaller than a second threshold value, it is determined in said checking that said degree of reliability of said service providing information and said degree of reliability of said facility use information are high.

45. The information providing system according to claim 27, wherein
when said degree of reliability of said service providing information is not smaller than a first threshold value or said degree of reliability of said facility use information is not smaller than a second threshold value, it is determined in said checking that said degree of reliability of said service providing information and said degree of reliability of said facility use information are high.

46. The information providing system according to claim 27, wherein
when a sum of said degree of reliability of said service providing information and said degree of reliability of said facility use information is not smaller than a third threshold value, it is determined in said checking that said degree of reliability of said service providing information and said degree of reliability of said facility use information are high.

47. The information providing system according to claim 44, wherein
when said degree of reliability of said service providing information is smaller than a fourth threshold value smaller than said first threshold value or said degree of reliability of said facility use information is smaller than a fifth threshold value smaller than said second threshold value, it is determined in said checking that said degree of reliability of said service providing information and said degree of reliability of said facility use information are low.

48. The information providing system according to claim 38, wherein
when the number of vehicles which has used the same said facility at predetermined times or more increases in a certain period, it is determined in said making that said facility is newly established.

49. A display control device for performing a control to display information based on said availability information acquired from said information providing system according to claim 23, on a display device, said display control device comprising:
a processor to execute a program; and
a memory to store the program which, when executed by said processor, performs a process of searching for a route from a present location of said vehicle to a destination by way of said facility,
wherein the timing of said searching is a time when said destination is set or a time when said vehicle needs to use said facility.

50. The display control device according to claim 49, wherein
said processor further performs a process of generating information to be displayed on said display device, on the basis of said availability information, and
said generating includes generating information of said facility, by which said facility which is available can be distinguished from said facility which is not available.

51. An information equipment, comprising:
a processor to execute a program; and
a memory to store the program which, when executed by said processor, performs processes of:
transmitting outside facility use information indicating that an own-vehicle has used a facility; and
receiving from said facility service providing information indicating that said facility has provided said own-vehicle with a service, and transmitting said facility use information to said facility,
wherein said transmitting includes transmitting outside said facility use information and said service providing information.

52. An information providing method, comprising the steps of:
acquiring facility use information indicating that a vehicle has used a facility and service providing information indicating that said facility has provided said vehicle with a service;
checking said facility use information with said service providing information, both of which are acquired in said acquiring; and
updating availability information indicating an availability state of said facility on the basis of a check result obtained in said checking,
wherein said checking includes checking said facility use information with said service providing information on a one-to-one basis.
